(19) United States
(12) Patent Application Publication
(10) Pub. No.: US 2007/0257175 A1
(43) Pub. Date: Nov. 8, 2007

(54) Apparatus to affix decorative items to stair treads

(76) Inventor: Mark J. Allen, Ringwood, NJ (US)

Correspondence Address: Mark J. Allen, 75 Pinewood Dr, Ringwood, NJ, 07456, US

(21) Appl. No.: 11/306,463

(22) Filed: Dec. 29, 2005

(51) Int. Cl. F16B 45/00; B42F 13/00

(52) U.S. Cl. 248/339; 248/304

(57) ABSTRACT

Many people seek new and novel ways to decorate their homes for the various seasons and holidays. They seek to create a warm and friendly atmosphere in their home and spend considerable time on their entrance hallways. These hallways usually contain the stairs to the second floor, are narrow and offer little room to decorate. Therefore the steps on the stairs become the base for decorating the entrance hall. Unfortunately, the current method of hanging garland and stockings and other items to the balusters require using wire which can damage the finish on the baluster and is usually unsightly. The stair tread fastening apparatus is an improvement over the traditional mantle stocking holders in that it is notched in the base to fit between the balusters of a step and thus adds to the decorations without damaging the balusters.

An apparatus is disclosed for securing decorative items such as garland, lights, Christmas Stockings on top of a stair tread over the side edge of the tread between two balusters that are attached to the same tread.

The apparatus has two notches cut into the base to secure the base against being pulled away from the stair. A hook on the face of the base secures the decorative item. The base may contain a seasonal decoration face plate to coordinate with hung decorative item.

What is claimed is:

1. Apparatus for holding items on and/or hanging items from the side of a stair tread which has at least two balusters fixed directly to the top of the stair tread. The apparatus base has notches in the sides which prevent the base from being pulled away from the balusters.

2. The apparatus consists of a heavy base which may be made of any metal, ceramic, wood or plastic item.

3. The front of the apparatus has a hook for fastening the item to the base and may be attached by means of a screw, a weld or affixed with glue.

4. The hook on the front of the apparatus may be molded as a single item with the base.

5. The front of the base may also be adorned with a face plate of any number of decorative items to conform with or complement the item(s) being hung up.

6. The baluster holder is simply rotated 90 degrees and inserted from the leading edge of the side of the stair tread. Once the notches are lined up with the balusters, the holder is then rotated back to the horizontal position and rested on top of the stair tread with the hook extending over the side.

7. The invention is will be better understood upon reading the following descriptions in conjunction with the attached drawings.

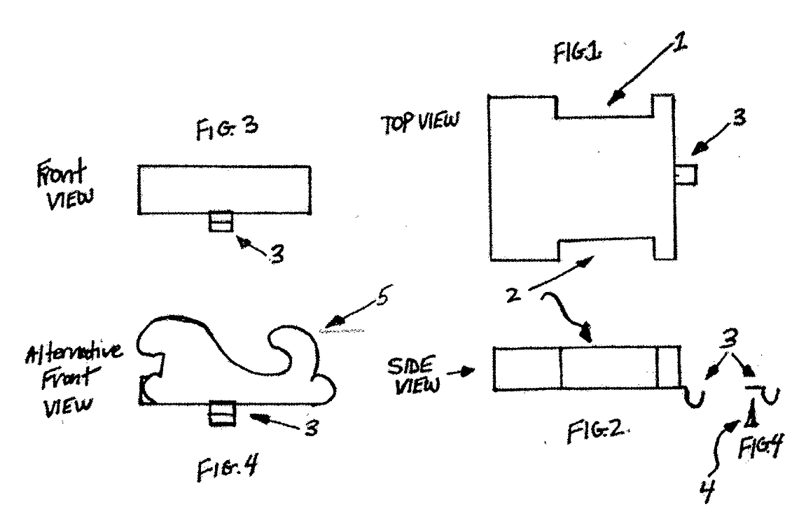

8. FIG. 1 shows the top view of the base with notches 1 and 2 cut into the base to fit between the balusters.

9. FIG. 2 shows the hook with will extend over the side of the stair tread.

10. FIG. 4 shows a sample of a decorative face plate which can be attached either by means of a screw, glue or during the manufacturing process.

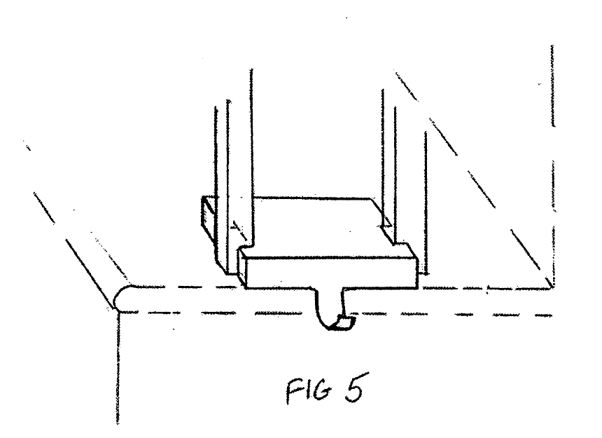

11. FIG. 5 shows the invention sitting between the balusters. Various sizes of the invention can be manufactured to conform to the various spaces between the balusters.
